(19) United States
(12) Patent Application Publication
(10) Pub. No.: US 2006/0080894 A1
(43) Pub. Date: Apr. 20, 2006

(54) Frame/filling combination

(76) Inventor: Heinrich Saelzer, Marburg (DE)

Correspondence Address: WILLIAM COLLARD;COLLARD & ROE, P.C., 1077 NORTHERN BOULEVARD, ROSLYN, NY, 11576, US

(21) Appl. No.: 11/245,779

(22) Filed: Oct. 7, 2005

(30) Foreign Application Priority Data
Oct. 8, 2004 (DE) 10 2004 049 414.2
Nov. 15, 2004 (DE) 10 2004 055 111.1

(51) Int. Cl. E06B 1/04

(52) U.S. Cl. 49/504

(57) ABSTRACT

A frame/filling combination, particularly in the form of a window or door, is provided for closing an opening in a wall that is to be closed and is delimited by a rough opening. The combination has a filling, for example a laminate glass pane, which is directly or indirectly accommodated in an opening of a frame under normal circumstances. In order to prevent the filling, in particular, from flying about uncontrollably from the effect of a pressure wave on the filling, the laminate glass pane is held in connection with the frame by a retention device, even if the laminate glass pane has burst out of the opening of the frame, as the result of a pressure effect, particularly an explosion-related pressure effect. The frame filling can be removed by the effect of pressure only if a connection device that holds it in the frame in the normal state is destroyed.

### CROSS REFERENCE TO RELATED APPLICATIONS

Applicant claims priority under 35 U.S.C. §119 of German Application No. 10 2004 049 414.2 filed Oct. 8, 2004 and German application No. 10 2004 055 111.1 filed Nov. 15, 2004.

### BACKGROUND OF THE INVENTION

1. Field of the Invention

The present invention relates to a frame/filling combination, particularly a window or a door for closing an opening to be closed in a wall that is delimited by a rough opening. The combination includes a filling, particularly a laminate glass pane, a frame having an opening for direct or indirect accommodation of the filling during a normal state, and a retention device mounted between the filling and the frame for holding the filling in connection with the frame.

2. The Prior Art

Windows and, in particular, casement windows, are fundamentally known in the state of the art. In the case of casement windows, a window frame is first typically provided in the opening of the wall, and it is anchored to the rough opening. A casement frame having a filling that is typically configured as a glass pane is mounted in the window frame, so as to turn and/or tilt. Such a casement window, as it is used for normal housing construction, is typically not configured for the stresses that occur under the effect of an explosion-related pressure wave or in connection with the component displacements that occur due to an earthquake. When an explosion-related pressure effect occurs, therefore, at least the glass would break. Depending on the intensity of the pressure effect, the casement frame would also break, Glass splinters and frame splinters would then fly about, in uncontrolled manner, and would represent a risk of injury for any persons present in the vicinity.

Furthermore, an explosion-resistant frame/glass combination is known from the state of the art, specifically from DE 20 2004 005 639 U1. The combination disclosed there has a filling in the form of a glass panel that is held by a metal profile frame. A high-strength strip of woven fabric or a high-strength woven fabric frame is glued between the individual glass panes of the glass panel. The fabric or fabric frame is glued in such a manner that part of the woven fabric projects beyond the edge of the glass panel as a tab. The tab is glued onto the metal profile frame. In the case of the effect of a pressure wave caused by an explosion, for example, the glass panel is held in the metal profile frame; only a short-term deformation of the glass panel occurs. In order to be able to compensate this deformation, the tab is configured to be elastic. In total, the combination is designed in such a manner that it withstands an explosion; in particular, the glass panel is continuously held in the metal profile frame, all around, before, during, and after the explosion.

In order to be able to guarantee this strength, the combination as a whole must be configured to be very stable, and this configuration is related with correspondingly high costs.

A catch device for window panels or door panels, to reduce the effect of a pressure or shock wave after an explosion, is proposed in WO 2005/075785 A1. The window panel or door panel has a panel profile that accommodates a windowpane and is accommodated in a doorframe or window frame (door/window frame) with an outer frame profile, in such a manner that the casement can be opened. In order to prevent parts of the window construction from flying around uncontrollably after destruction of the window due to the impact of a pressure wave or suction wave, a closed chamber is present, or an additional pipe is disposed in the window profile according to WO 2005/075785 A1, in which a rope or belt is laid. The ends of the rope or belt are attached to the window frame or to a ceiling or wall. Therefore, a very stress-resistant but flexible connection between the casement frame and the window frame is created with this window.

However, because of the ropes that must be guided between casement frame and window frame, this window has the great disadvantage that a configuration as a turning/tilting window is not possible, since the free rope length that would be required for this configuration cannot be stowed away during the closing process, in ordered manner, without problems. Furthermore, there is the risk that the pane as a whole would come loose from the casement frame and be thrown into the room. This risk cannot be prevented even by a very durable connection between the casement frame and the window frame.

### SUMMARY OF THE INVENTION

Proceeding from this state of the art, it is an object of the present invention to further develop a known frame/filling combination so that it allows pressure relief in the case of the effect of a pressure wave, particularly an explosion-related pressure wave, from the interior of a building or from the outside, i.e. pressure equalization, without its filling flying around in uncontrolled manner, for example in the form of a glass pane or splinters of the glass pane, because of the effect of the pressure wave, and representing a risk of injury. Also, in earthquakes, the filling should be prevented from falling out of the frame because of the displacement of the building parts relative to one another.

These and other objects are accomplished according to the invention, by a frame/filling combination in which the filling, for example in the form of a glass pane, preferably a laminate glass pane, can be held in connection with the frame, by means of the retention device, even if the filling has come loose from the opening of the frame as the result of the effect of a force, particularly an explosion-related force. In accordance with the invention, the filling can be removed from the frame by means of the effect of a force only if the connection device that holds it in the frame in the normal state is destroyed.

The terms “normal state,” “under normal circumstances,” and “normally” are to be understood, in the present specification, to designate a state without the effect of a pressure wave, particularly an explosion-related pressure wave, or an earthquake on the frame/filling combination.

Furthermore, the term “ . . . for direct accommodation of the frame filling” means that the frame filling as such is accommodated in the opening, particularly without being directly clamped into an auxiliary frame. In contrast, “ . . . an indirect accommodation of the frame filling in the opening” means that the frame filling is mounted in the opening together with an auxiliary frame that accommodates it directly. Furthermore, the special embodiment of the filling as a laminate glass pane is to be understood merely as an example in this application; of course, the filling can also be made of wood, plastic, metal, or another material, and also a non-transparent material.

This embodiment of the frame/filling combination advantageously can operate as a pressure-relieving flap. The retention device acts as a type of hinge, among other things, and allows the filling to come loose from the opening of the frame that accommodates it, in the case of an effect of a pressure wave on the filling, and thereby to give way to the pressure wave. However, it is advantageous that then, the filling is held in connection with the frame in the opening of which it was previously accommodated, by means of the retention device. It is also held in connection with a rough opening to which the frame/filling combination is attached, by way of the frame. Accordingly the filling, in particular, is advantageously prevented from coming loose from its connection with the frame and the rough opening, by means of the retention device. The filling is therefore prevented from causing damage as a freely moving individual part that is accelerated by the pressure wave, for example in the interior of a room or in an outside area in front of the building. At the same time, however, pressure equalization between the rooms or areas that were separated by the frame/filling combination before the pressure effect is also implemented in that the filling bursts out of the opening. The pressure equalization is thereby provided according to the invention in a controlled manner. This controlled pressure equalization makes it possible to configure the frame/filling combination to be only so stable that it withstands the pressure wave that is weakened by the pressure equalization. This arrangement is less expensive than if the combination would have to be configured so that it would withstand the pressure wave even without any pressure equalization.

It is furthermore advantageous that the described pressure equalization takes place in controlled manner, according to the invention. To implement this controlled pressure equalization, a connection device configured as a planned breaking point is provided between the glass pane and the frame that normally accommodates it, according to the invention. The connection device is configured in such a manner that it releases the connection between the filling and the frame that it implements only at a pressure effect above a predetermined force threshold value on the outside of the frame filling.

It is important that the retention device produces a non-releasable connection to the glass pane, so that it can be prevented from coming loose and being thrown about. It is not sufficient to connect a casement frame, for example, sufficiently firmly with a blind casement or building part (ceiling, wall, rough opening, etc.), but for the remainder to disregard the connection between glass pane and casement frame. This connection is configured in such a manner, according to the invention, that the glass pane remains in its position relative to the frame (casement frame or window frame) with sufficient strength and security in the normal state. In particular, it is necessary for the glass pane to withstand the usual “operational forces,” i.e. wind forces or forces during cleaning or usual contact with or support against the pane, in the normal state. A connection device that fulfills these requirements can be configured, for example, in the form of silicone dots or silicon bead sections. The connection device can also be configured as circumferential silicone seals that are formed to be sufficiently weak. They can also be configured in the form of a sufficiently resilient, particularly L-shaped rubber or plastic profile seal, or in the form of a glass holder strip, which is connected sufficiently weakly with the frame by means of an appropriately structured glue bond or by means of tear-away screws, magnetic holders, or spring clamps, or the like.

In the construction according to the invention, the glass pane and also the frame elements are therefore able to be formed to be comparatively weak. This feature has a very positive effect on the costs: Thus it is merely necessary, with regard to the glass pane, i.e. filling, that the filling does not lose its cohesion, i.e. particularly does not shatter. It is therefore particularly recommended to use a laminate glass pane having at least one film located between two individual panes, which assures an elastic and strong cohesion of the laminate glass pane. Alternatively, a flexible plastic pane, for example made of polycarbonate (Plexiglas) can also be used. The retention device prevents the glass pane that has previously come loose from the frame from flying around in uncontrolled manner. However, by means of the pane coming loose, a release of an opening cross-section is brought about, which makes pressure equalization between the two sides of the pane possible. Because of this pressure equalization, the remaining forces that act on the glass pane, and also on the frame elements, are reduced. As a result, no particularly stable and cost-intensive construction is required, as is required in a window construction intended to withstand a pressure wave without any kind of damage, i.e. particularly is not supposed to allow any kind of connection between the two sides of the frame/glass combination to come about.

A particular advantage of the configuration according to the invention is that because of the attachment of the retention device to the glass pane, in the case of a connection of the other end of the retention device with a casement frame, the casement frame can usually be moved freely in a window frame. In this case, the window according to the invention can be both turned and tilted, without any holding ropes or wires being present between the casement frame and the window frame. Therefore, it offers sufficient protection in the case of an explosion-related pressure effect or a force effect triggered by an earthquake, both in the closed position and in the tilted position: In the closed state, even commercially available reinforced locking mechanisms are sufficiently stable to hold the casement frame in the window frame, since after the glazing has come loose from the casement frame, the only forces that still act on the casement frame, including the forces to be transferred by the retention device, are comparatively low. The same applies for the case where the window is in a tilted position.

The ability of the bands and tilt scissor mechanisms with which the casement is typically coupled with the window frame to withstand stress must be sufficiently great so as to loosen the connection device between glass pane and casement frame.

This ability must also be sufficiently great so as to absorb the forces to be transferred to the casement frame by the retention device after release of the pressure equalization cross-section. As previously explained above, the holding forces required for the casement frame after the glazing has come loose and pressure equalization has come about are comparatively low. Coordination of the maximum ability of the retention device to withstand stress must therefore always take place in such a manner that it is greater than the maximum ability of the connection device to withstand stress.

It is advantageous that the invention can be used both with fixed windows, in other words windows that are normally not opened, and with casement windows.

It is advantageous that the retention device can be configured according to a first embodiment, as a rope or band, and/or according to a second embodiment, as an auxiliary frame having bands in the sense of (rotary) bearings. Both exemplary embodiments offer the advantage of allowing the frame filling to be surrounded by the rope or band. In this way, the rope or band keeps the frame filling held firmly as well as together in case of the effect of a force. In this regard, the retention device also represents a preventive measure for avoiding the formation of splinters. When using a rope, it is furthermore advantageous if the retention device has an attachment device (e.g. rope clamps or the like) for attaching the rope or band.

It is advantageous if the retention device is built into the frame/filling combination in such a manner that it is not visible from the outside of the combination. The optical, i.e. aesthetic overall impression of the frame/filling combination as a normal window or a normal door is then not disrupted.

If the retention device is formed as a rope or band, the rope or band is advantageously guided in a groove formed at the circumference of the frame filling. Optionally, the groove, which is preferentially circumferential, may be filled with a sealing mass, together with the rope or band guided in it. The sealing mass serves to protect the rope or band—also against the effect of moisture—and also possesses an effect that improves the holding effect, because of its adhesion strength. Laying the rope or band into the groove serves, in particular, to hide the rope or band from sight. The rope or band is invisibly covered in the installed state of the glass, by means of the glass holder strips or a projecting ridge of the casement frame or window frame.

If a pressure wave of an explosion proceeds from the interior of a building, for example in the case of silo buildings, the filling is preferably formed as a panel piece and integrated into the building facade. In this way, the filling makes a contribution to pressure relief. In this connection, the panel piece can be made of several individual pieces; however, these pieces, in total, are maintained as a unit even in the loosened state.

According to an advantageous further embodiment, the retention device comprises at least two limitation devices for limiting the length of the path by which individual points of the filling, particularly the laminate glass pane, remove themselves from the frame as the result of an explosion-related pressure effect, which limitation devices are rigidly connected with the laminate glass pane and the frame, in each instance. The at least two limitation devices are disposed on the circumference of the laminate glass pane, distributed as uniformly as possible. This uniform distribution of the limitation devices advantageously prevents the laminate glass pane from swinging up, with a large action radius, into an interior room behind the laminate glass pane in the case of an explosion-related pressure effect. This uniform distribution is in contrast to a merely point-by-point connection between laminate glass pane and frame. Such a sudden and uncontrolled upswing of the laminate glass pane—or a similar turning movement—would represent a significant safety risk for persons who might happen to be in the vicinity behind the pane at the time of the explosion.

Suitable limitation devices are produced, for example, in the form of limitation scissor mechanisms or in the form of rope or band segments (generally tension means) having a predetermined length, whereby the ends of these limitation devices are rigidly connected with the laminate glass pane and the frame or a building part, in each instance, as previously stated.

The limitation devices are advantageously mounted in at least one space, so as to be invisible to an outside observer of the frame/glass combination during the normal state. For example, the limitation devices may be mounted in an interstice between the frame and the laminate glass pane, or a cavity in the frame. It should be noted that the limitation devices must be mounted to be freely movable within this space, so that in case of an explosion-related pressure effect, they can instantly open up fully, i.e. to their maximum length.

Finally, it is advantageous, where the retention device and the limitation device are in the form of a rope or band, if the coupling device is configured to clamp a free end of the rope or band, in each instance, in order to rigidly connect these free ends with the frame, in each instance.

Further advantageous embodiments of the frame/filling combination are discussed below.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a profile view of a fixed field as a first embodiment of the frame/filling combination, with a first exemplary embodiment according to the invention for a retention device and a first exemplary embodiment for a connection device;

FIG. 2 shows the combination according to FIG. 1, with a first exemplary embodiment for the retention device and a second exemplary embodiment for the connection device;

FIG. 3 shows a first variant of the first exemplary embodiment of the retention device;

FIG. 4 shows a second variant of the first exemplary embodiment of the retention device;

FIG. 5 shows a third variant of the first exemplary embodiment of the retention device;

FIG. 6 shows a second exemplary embodiment for the retention device in the case of installation in the frame/filling combination before the effect of a pressure wave;

FIG. 7 shows a second exemplary embodiment for the retention device in the case of installation in the frame/filling combination after the effect of a pressure wave;

FIG. 8 is a profile view of a casement window as a second embodiment of the frame/filling combination, with the first exemplary embodiment of the retention device and the second exemplary embodiment of the connection device;

FIG. 9 shows the casement window in the normal state, with the first exemplary embodiment of the retention device and the first and second exemplary embodiment of the connection device;

FIG. 10 is a frontal view of the casement window with a first variant of the first exemplary embodiment of the retention device;

FIG. 11 is a frontal view of the frame/filling combination, with a second variant of the first exemplary embodiment of the retention device;

FIG. 12 is a profile view of the casement window in the normal state, with a third variant of the first exemplary embodiment of the retention device;

FIG. 13 is a frontal view of the frame/filling combination, with the third variant of the first exemplary embodiment of the retention device;

FIG. 14 is a profile view of the casement window in the normal state, with a second exemplary embodiment of the retention device;

FIG. 15 shows the casement window according to FIG. 14, but after a pressure effect;

FIG. 16 is a frontal view of a fixed field as a first embodiment of the frame/glass combination, with a fourth variant for the first exemplary embodiment of the retention device;

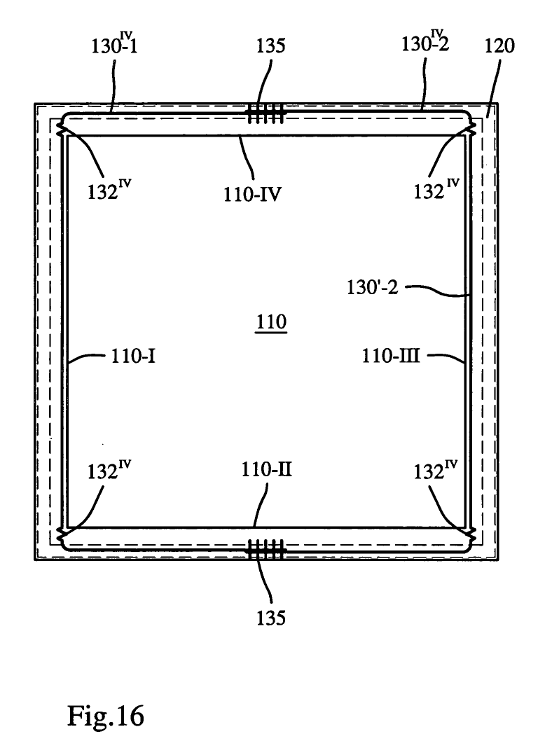

FIG. 17 is a profile view of the first embodiment of the frame/glass combination, with the fourth variant for the first exemplary embodiment of the retention device, in a normal state;

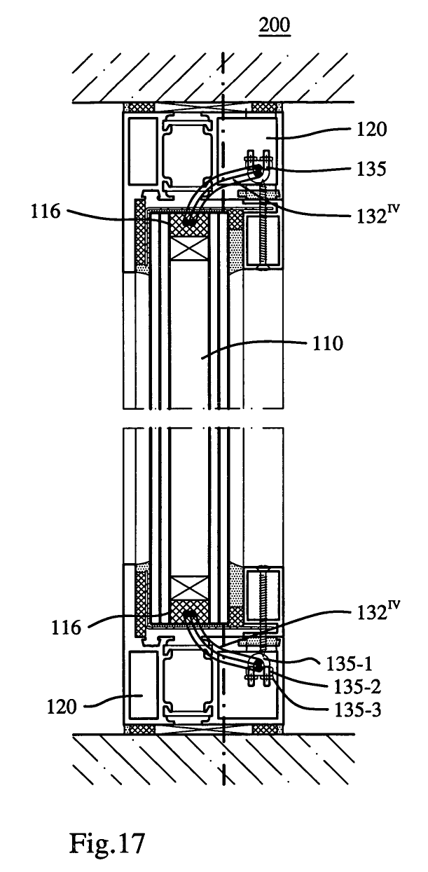

FIG. 18 is a profile view of the first embodiment of the frame/glass combination, with the fourth variant for the first exemplary embodiment of the retention device, after an explosion-related pressure effect;

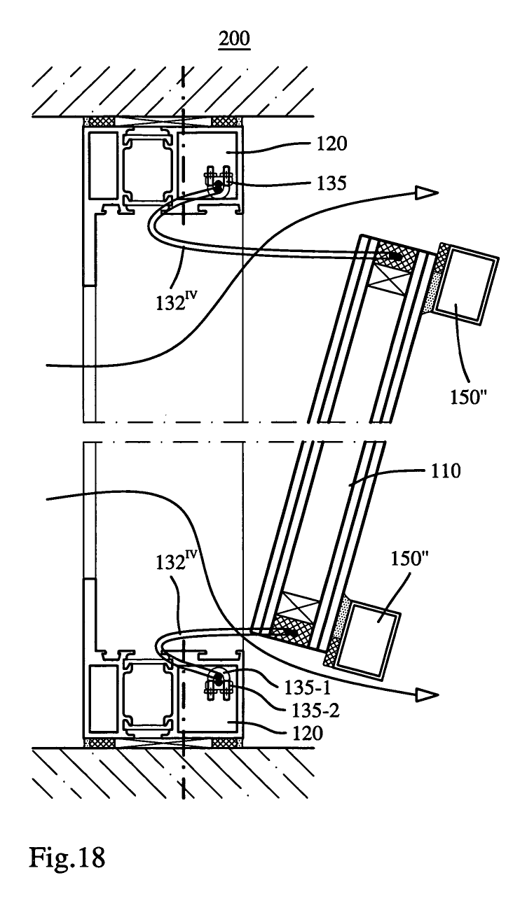

FIG. 19 is a frontal view of a fixed field in a normal state, with a fifth variant for the first exemplary embodiment of the retention device;

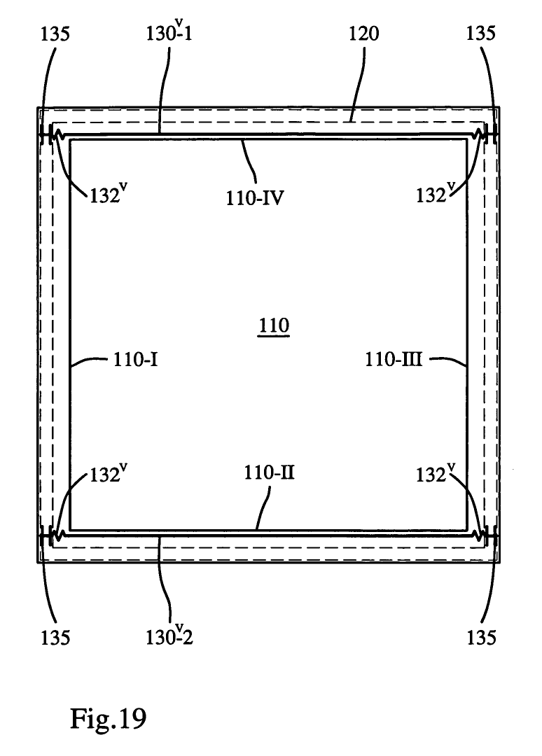

FIG. 20 is a frontal view of a fixed field in a normal state, with a sixth variant for the first exemplary embodiment of the retention device;

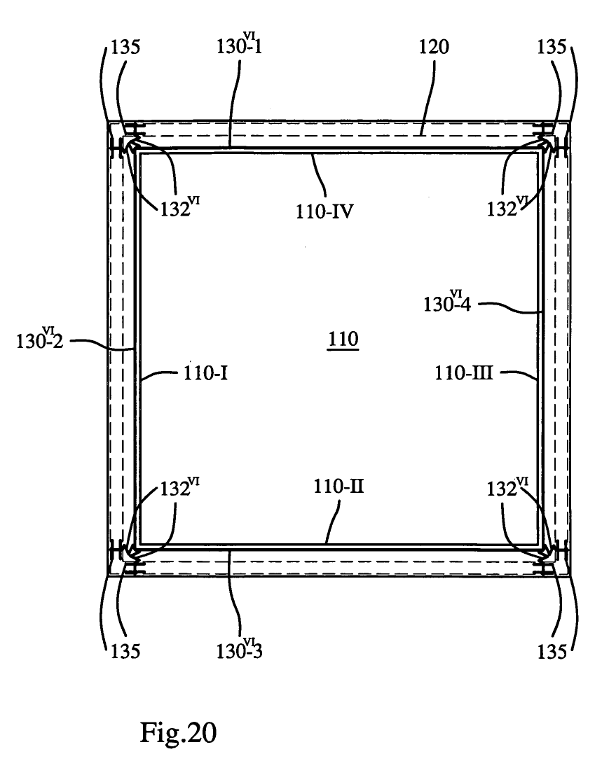

FIG. 21 is a frontal view of a casement window as a second embodiment of the frame/glass combination in a normal state, with the sixth variant for the first exemplary embodiment of the retention device;

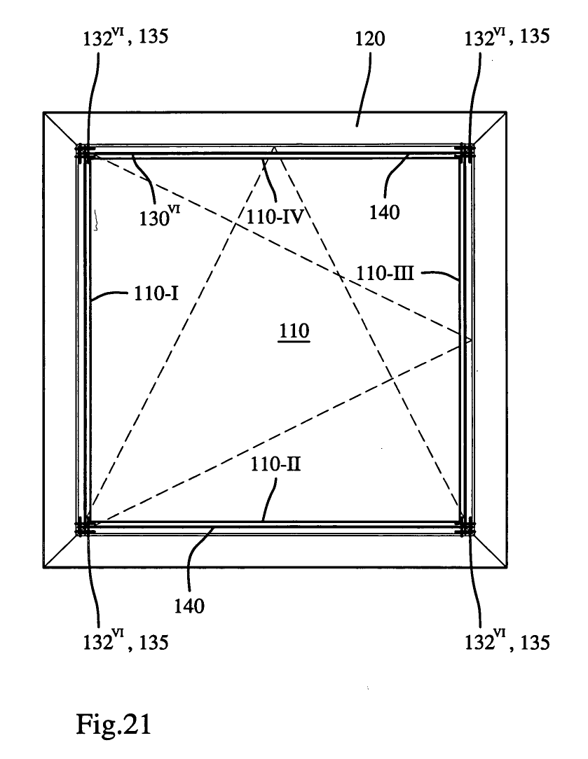

FIG. 22 is a frontal view of a casement window as a second embodiment of the frame/glass combination in a normal state, with the fourth variant for the first exemplary embodiment of the retention device;

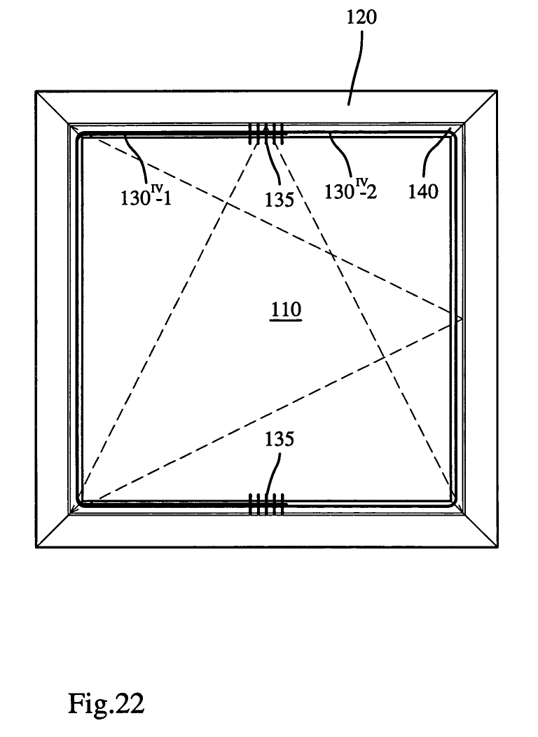

FIG. 23 is a frontal view of a casement window as a second embodiment of the frame/glass combination in a normal state, with the fifth variant for the first exemplary embodiment of the retention device;

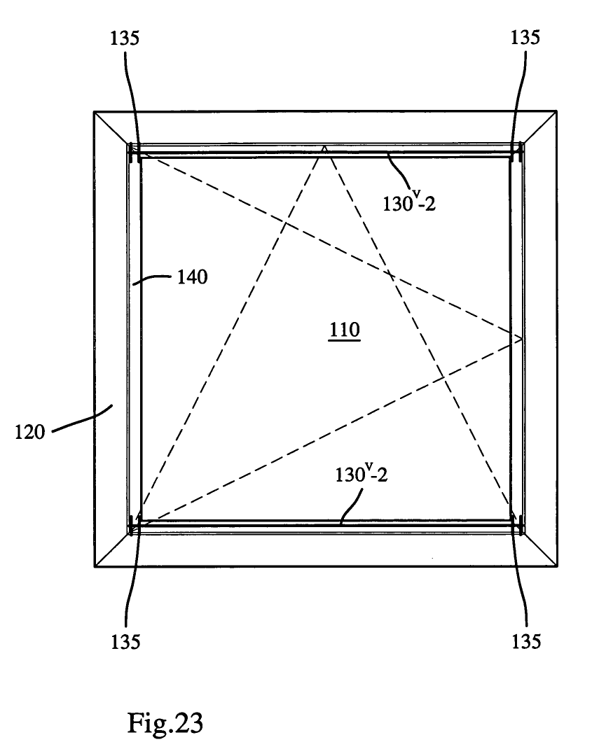

FIG. 24 shows a limitation scissors mechanism;

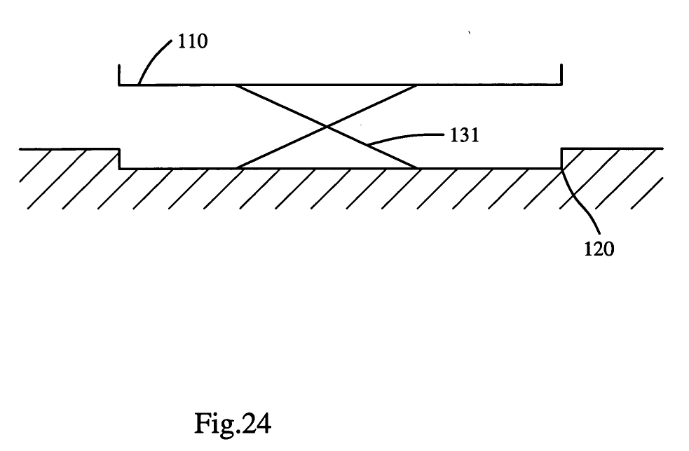

FIG. 25 is a view of a partition within a room in a building;

FIG. 26 is a horizontal section through the partition according to FIG. 25;

FIG. 27 is a vertical section through the partition according to FIG. 25;

FIG. 28 is a vertical section through a pressure relief flap with glazing for pressure relief on both sides;

FIG. 29 is a vertical section through the connection device of the pressure relief flap according to FIG. 29;

FIG. 30 shows an alternative connection device for the pressure relief flap according to FIG. 29;

FIG. 31 is a vertical section through another alternative embodiment in the form of a window/door element;

FIG. 32 is a vertical section through another alternative embodiment in the form of a window/door element;

FIG. 33 is a vertical section through another alternative embodiment in the form of a window/door element, in the case of a fixed field, with an alternative retention device;

FIG. 34 shows an alternative embodiment in the case of a fixed field;

FIG. 35 shows an alternative embodiment in the case of a fixed field, with an alternative fixation of the glass holder strips.

### DETAILED DESCRIPTION OF PREFERRED EMBODIMENTS

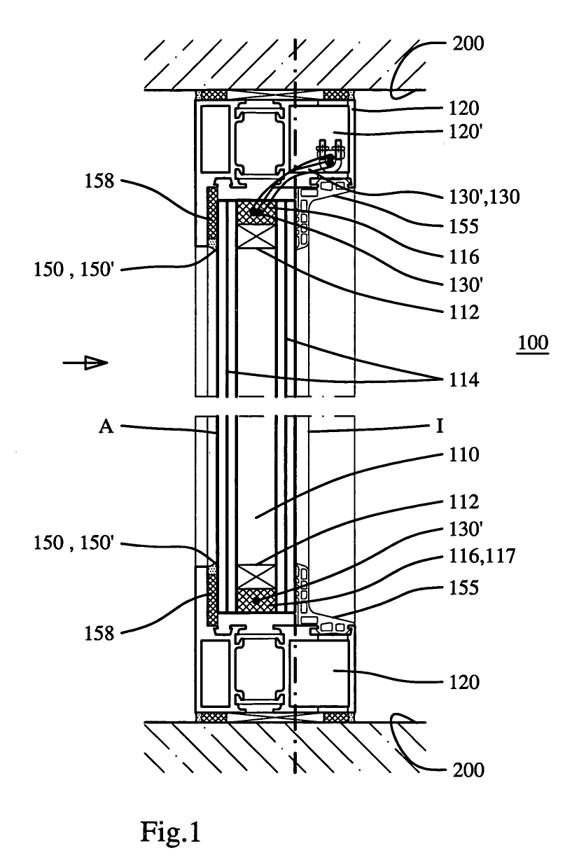

Turning now in detail to the drawings, FIG. 1 shows the frame/filling combination 100 according to the invention in a profile view. FIG. 1 shows the combination in a normal state. In other words, frame/filling combination 100 is shown before the effect of a pressure wave, particularly an explosion-related pressure wave. Frame/filling combination 100 in FIG. 1 is a window for closing an opening in a wall, limited by a rough opening 200. Frame/filling combination 100 comprises a frame filling 110, which is directly accommodated, i.e. embedded, in an opening of a frame 120. Frame 120 is anchored in rough opening 200 so firmly that it would withstand a possible explosion-related pressure wave. The combination shown in FIG. 1 is formed as a fixed window. In other words, opening of the window is not planned. In the case of the effect of a pressure wave on the outside A of the combination, and in particular on frame filling 110, however, frame filling 110 is intended to burst out of the frame in which it is normally embedded. In order to assure this result, a connection device 150 formed as a planned breaking point is provided between frame filling 110 and frame 120. This device is preferably a sealant bead 150′, for example of silicone, whereby the adhesive strength of the sealant bead is selected on the basis of a predetermined pressure threshold value. Only if the pressure wave coming from the direction of the arrow exerts a pressure force on frame filling 110 that is greater than the predetermined pressure threshold value will connection device 150′ give way. Only then will frame filling 110 burst out of the opening, i.e. from its embedding in frame 120, in the direction of the arrow.

The configuration of the connection device in the form of merely the sealant bead 150′ represents a first exemplary embodiment for the connection device. In addition to sealant bead 150′, a cover band 158 can also be provided between frame 120 and frame filling 110′. On the side of frame filling 110 that lies opposite sealant bead 150′, a sealing profile 155 can be provided for sealing and holding frame filling 110 relative to frame 120, on the inside I of frame 120. Sealing profile 155 is also destroyed in the case of the effect of a pressure wave, and does not prevent frame filling 110 from bursting out of the opening of the frame 120. In total, the sum of the holding forces of sealant bead 150′ and sealing profile 155 is less than the maximum holding force of the masonry anchors used to fix frame 120 in place. It is also less than the bursting strength of frame filling 110. Sealant bead 150′ and sealing profile 155 thereby represent the weakest links of the entire window construction in the case of a pressure impact from the outside A.

In order to keep frame filling 110 that has burst out of the opening from flying around in uncontrolled manner after the pressure effect, frame/filling combination 100 according to the invention has a retention device 130. In FIG. 1, a rope or band 130′ is shown as a first exemplary embodiment of this retention device. The rope or band can be guided in different ways. Each of these ways represents a respective variant of the first exemplary embodiment of the retention device. A second variant is shown in FIG. 1, whereby the rope surrounds frame filling 110 along its circumference, and is guided in a groove 116 that is formed at the edge of frame filling 110. Groove 116 is filled with a sealing mass 117. Groove 116 is formed at the circumference of frame filling 110, in that spacers 112 provided in the frame filling, which have the task of holding individual glass panes 114 of frame filling 110 apart from one another, do not end flush with the edge of the frame filling. Rather the spacers are offset towards the center of frame filling 110, on the circumference, relative to this edge.

Because of its guidance in groove 116 and its anchoring in a profile interior chamber 120′ of frame 120, rope 130′ cannot be seen from the outside when combination 100 is viewed from the outside, from the direction of the arrow. Rope 130′ and its anchoring are configured to be so stable, according to the invention, that they limit frame filling 110 from continuing to move in case it bursts out of the opening of frame 120, and continue to hold it in connection with frame 120. In this way, frame filling 110 that has burst out is prevented from flying around in uncontrolled manner.

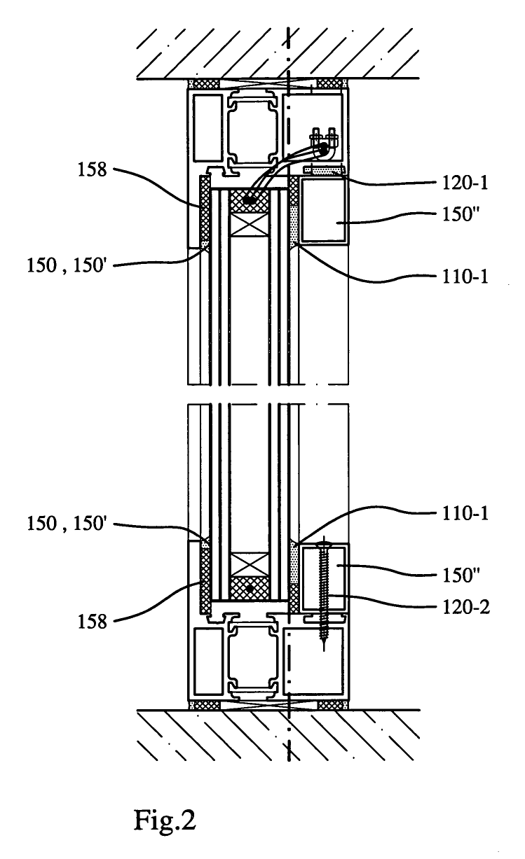

FIG. 2 shows essentially the same fixed field as FIG. 1, but with the difference that in FIG. 2, not only a first but also a second exemplary embodiment 150″ for the connection device is shown. Here, the second exemplary embodiment is formed as a glass holder strip 150″ made from a metal profile having a rectangular cross-section.

The glass holder strip is connected with frame 120, on the one hand, and with frame filling 110, on the other hand. Connecting glass holder strip 150″ with the frame 120 can take place by means of silicone adhesion regions 120-1 or screws 120-2, for example aluminum screws. Connecting this glass holder strip 150″ to frame filling 110 can take place either by means of a silicone seal or a rubber gasket 110-1. The use of a silicone seal offers the advantage that glass holder strip 150″ continues to adhere to frame filling 110 in case of an explosion, provided its connection to frame 120 is made appropriately weak. Glass holder strip 150″, along with sealant bead 150′, functions, in particular in connection with silicone adhesion regions 120-1, as part of connection device 150 for connecting frame filling 110 with frame 120. If different exemplary embodiments of the connection device are combined, it must be noted that these, in their overall effect, define the pressure threshold value.

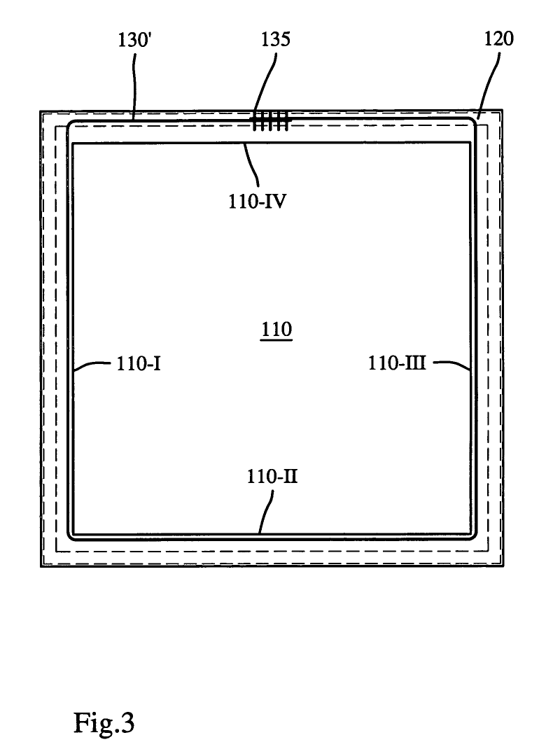

FIG. 3 shows an outside view of the fixed field shown in FIGS. 1 and 2, with a first variant for the use of the rope (first exemplary embodiment) as the retention device. As shown in FIG. 3, rope or band 130′ loops around the three sides 110-I . . . III of frame filling 110, in the first variant shown here. The rope or band is also guided in frame 120 parallel to a fourth side 110-IV of glass pane 110, and anchored there.

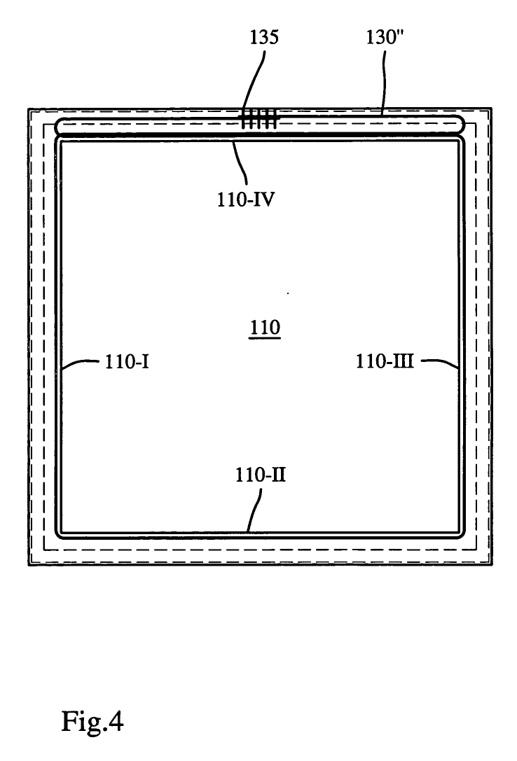

In contrast to FIG. 3, FIG. 4 shows the second variant for laying the rope as the retention device already known from FIG. 1, in a top view. In the case of this second variant, the three sides 110-I . . . III of frame filling 110 are surrounded by rope 130″ once, and the fourth side 110-IV of glass pane 110 is surrounded twice. Furthermore, the ends of the rope or band, which are still free after surrounding the fourth side twice, are introduced into frame 120 that directly accommodates frame filling 110, and are passed back in this frame, in the direction of the center, and anchored there. The coupling device 135 shown in FIGS. 3 and 4, for connecting the free ends of the rope, in each instance, is preferably configured as a bracing device for bracing the ropes. Bracing offers the advantage of a more stable hold in the case of a pressure effect.

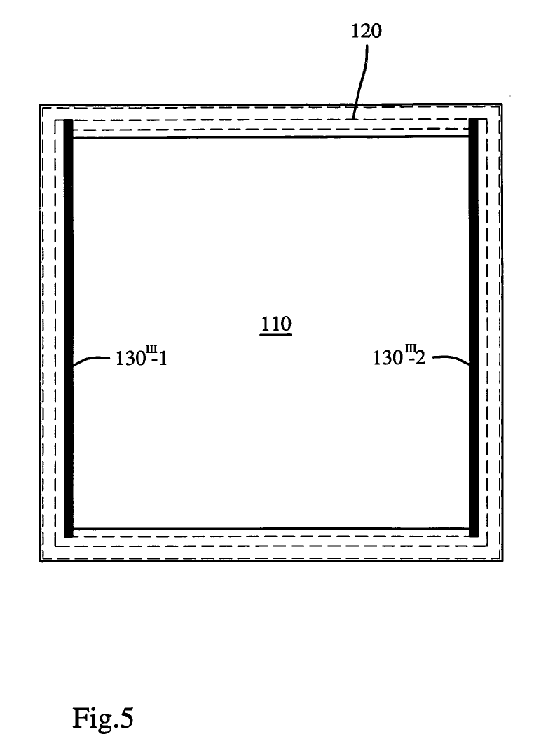

FIG. 5 shows a third variant for the use of a rope or band as the retention device. Here, it is indicated that alternatively to the variants shown in FIGS. 3 and 4, two ropes or bands can also be used as the retention device, which are guided not along the circumference of the frame filling in a frontal view, but rather along the circumference of frame filling 110 in its profile view. As in the case of the variants shown above, also where the individual bands are configured as respective closed loops, the two ropes 130′″-1 and 130′″-2 are also configured as respective loops, which run along the front and rear frontal sides of the laminate glass 110 as edge strips, in the case of this third variant. The loops are anchored in frame 120 which accommodates laminate glass 110.

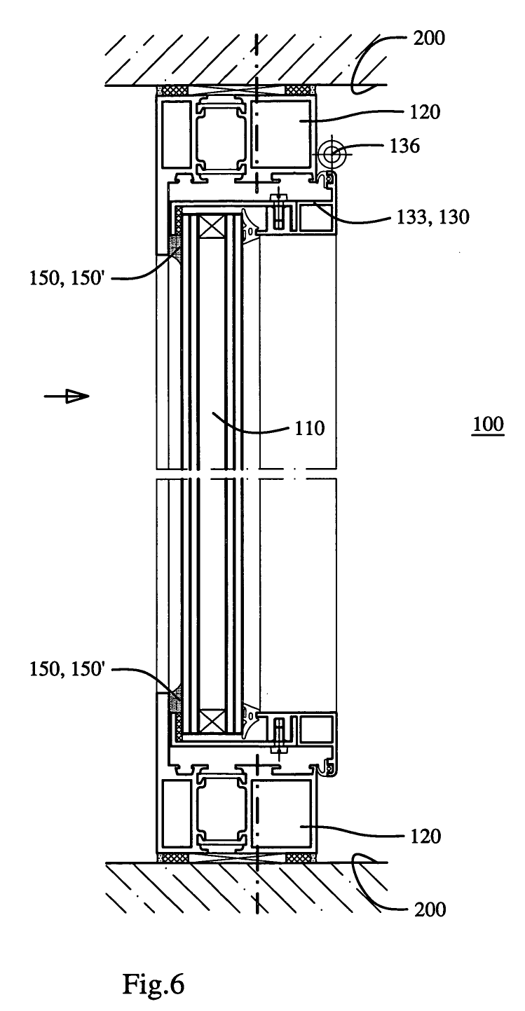

FIG. 6 again shows the fixed field previously shown in the preceding figures, but this time with a second exemplary embodiment for retention device 130. In the case of this second exemplary embodiment, retention device 130 is formed not as a band or rope, but rather as an auxiliary frame 133 in connection with bands 136. In this case, auxiliary frame 133 accommodates the frame filling 110 directly. In contrast, frame 120 does not accommodate the frame filling 110 directly, but rather only indirectly, because of the auxiliary frame 133 that comes in between. However, the function principle in the case of a pressure effect for this second exemplary embodiment is not different from the three variants of the exemplary embodiment of the retention device described above.

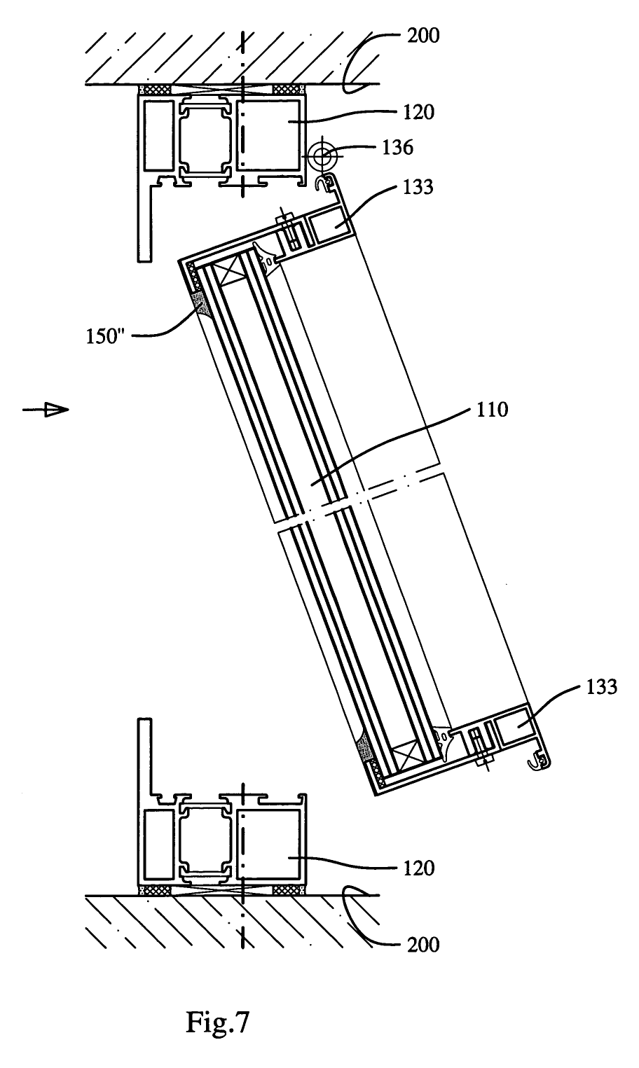

Thus, the connection devices 150, 150′ shown in FIG. 6 are also designed as planned breaking points, and release frame filling 110 in the case of a pressure effect from the direction of the double arrow. Frame filling 110 would then remain braced in the auxiliary frame and would perform a rotational movement about a point of rotation defined by bands 136, together with the auxiliary frame; see FIG. 7. In the case of the second exemplary embodiment for retention device 130 as shown in FIGS. 6 and 7, it must be noted that auxiliary frame 133 should not be confused with a conventional casement window, although here, it has the function of a casement frame, in principle. In contrast to a conventional casement window, the exemplary embodiment shown here is not intended to be opened in a normal state; instead, it opens only under a predetermined pressure effect. Thus, no fittings or handles are provided on the window shown here, for example to be able to open the window for ventilation or cleaning, and this absence of fittings or handles is intentional. Opening under normal circumstances is prevented by connection device 150.

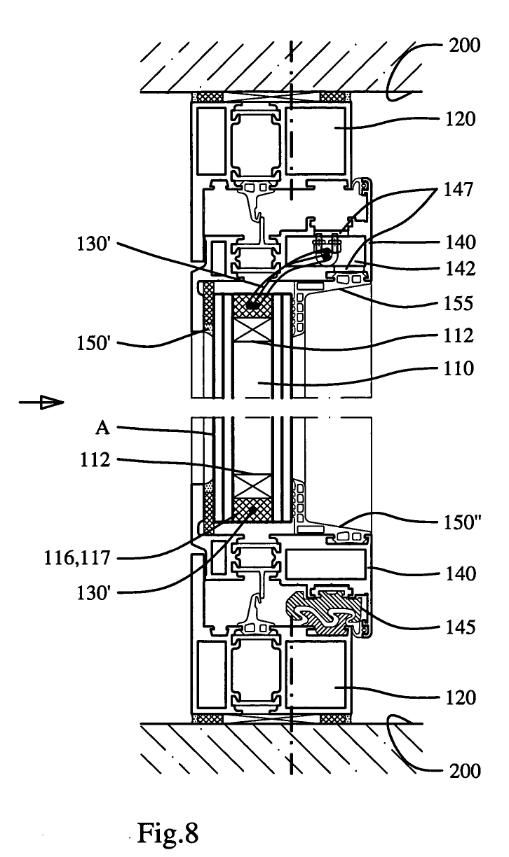

In contrast to FIGS. 1 to 7 described above, which all relate to a fixed field as a first embodiment of frame/filling combination 100, all of FIGS. 8 to 14 described below relate to a casement window as a second embodiment of the frame/filling combination according to the invention. A casement window differs from a fixed field in that it can be opened and closed even under normal circumstances. The explanations given above with regard to FIGS. 1 to 7 fundamentally apply equally to the following FIGS. 8 to 14. In particular, the explanations given above apply with regard to the structure of the frame/filling combination, connection device 150, retention device 130, and laminate glass 110. It should be remembered that like components are referred to with the same reference symbols. In order to simplify the description, the following FIGS. are only described to the extent that they demonstrate differences from one of the FIGS. discussed above, or show entirely new aspects.

Thus, FIG. 8 shows a profile view of a casement window according to the invention. It differs from the fixed field shown in FIG. 1 merely in that frame filling 110 is mounted not directly in the opening of frame 120, but instead in the opening of a casement frame 140.

Casement frame 140 in turn is mounted in frame 120, which is referred to as a window frame in the case of casement windows, so as to turn, pivot, tilt, or flip. This mounting allows the window to open even under normal circumstances. However, the bands (not shown here) required for opening and closing casement frame 140 relative to window frame 120 and the locking elements 145 required for closing are each made massive enough to withstand a pressure wave, particularly an explosion-related pressure wave. This arrangement has the result that when such a pressure wave occurs, casement frame 140 would not be moved or opened relative to window frame 120. Rather, the connection device 150, here made of the sealant bead 150′, would give way, so that then only frame filling 110 would burst out of casement frame 140. Frame filling 110 is generally heavy. In order to prevent frame filling 110 from flying about uncontrollably in this case, the retention device, formed as a rope 130′ here, is firmly anchored in a profile chamber 142 of casement frame 140, for example. It is advantageous if access openings 147 to profile chamber 142 are provided in casement frame 140, in order to be able to implement anchoring and possible bracing of ropes 130′ there. Anchoring in casement frame 140 instead of in the window frame 120 offers the advantage, in the case of casement windows, that this anchoring does not hinder opening and closing, i.e. a movement of casement frame 140 relative to window frame 120.

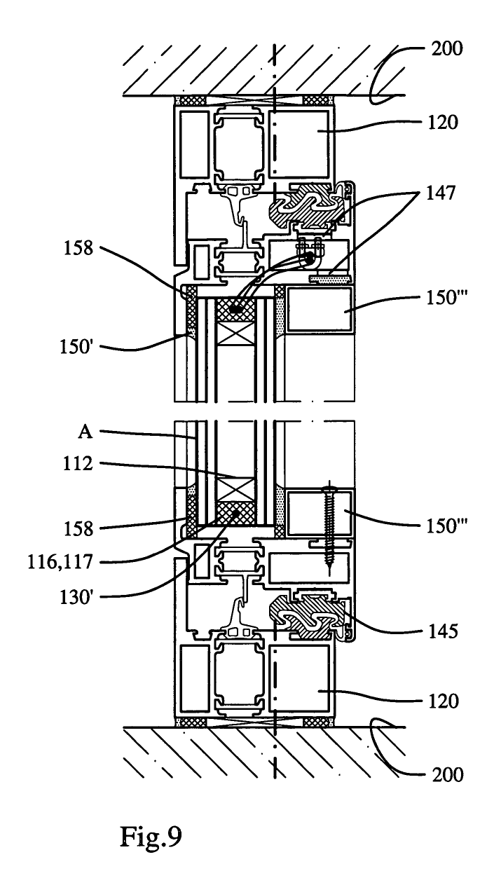

FIG. 9 shows essentially the same profile view of a casement window as FIG. 8, but with the difference that here, connection device 150 has not only sealing bead 150′ but also, instead of sealing profile 150″, the glass holder strip 150′″. Glass holder strip 150′″ was previously described in detail above, under FIG. 2.

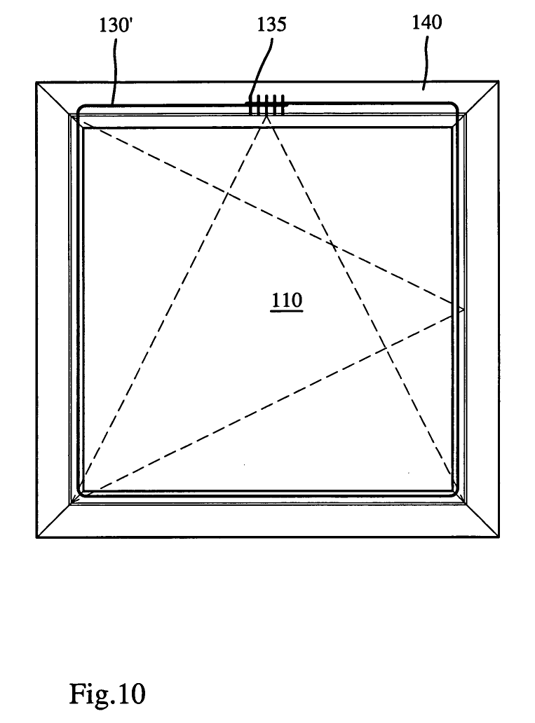

FIG. 10 essentially corresponds to FIG. 3, but with the difference that in FIG. 10, rope 130′ is not passed back into and braced in window frame 120, but rather in casement frame 140. The triangles indicated with a broken line in the FIG. indicate possible opening variants, for example turning or flipping of casement frame 140.

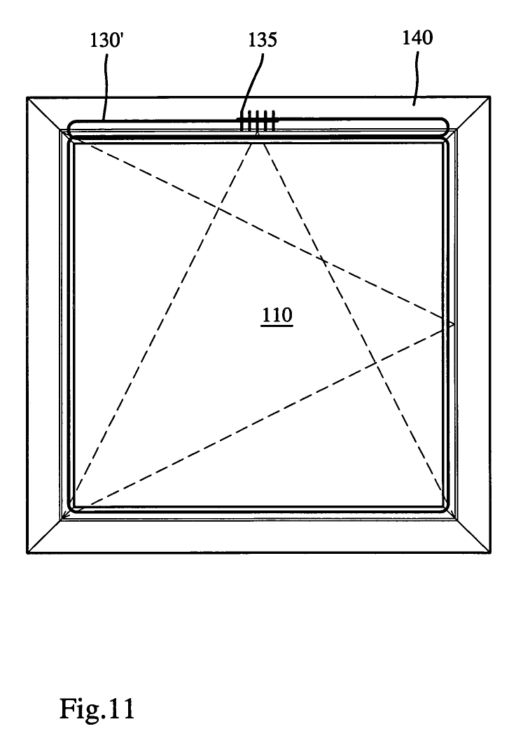

FIG. 11 shows an outside view of a casement window with bracing of the rope as the retention device in the form of a second variant, as it was already described in detail in FIG. 4 above. As a significant difference relative to the bracing in a fixed field, it can be determined, in the case of the casement window shown here, that the rope ends are passed back and the rope loop is braced not in window frame 120. Rather, the rope loop is braced in casement frame 140. Here again, the broken lines symbolize possible opening variants of the window casement, i.e. casement frame 140.

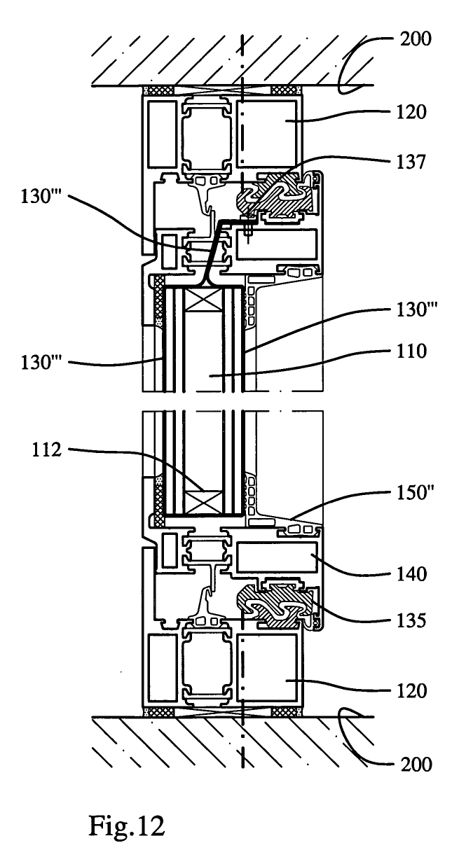

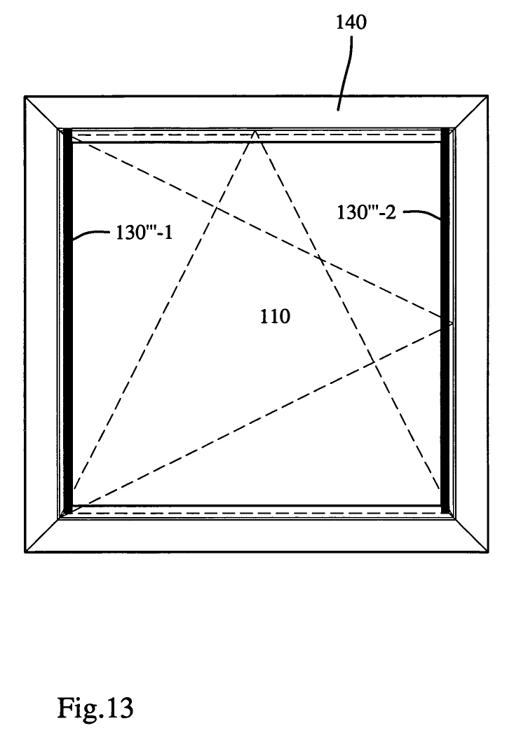

FIG. 12 again shows a profile view of a casement window, but with a third variant of the first exemplary embodiment of retention device 130. In the case of this third variant of retention device 130, preferably two ropes or bands are used rather than one. In contrast to the first and second variant, which provided for looping around the frame filling in the case of a frontal view, the third variant provides for looping around frame filling 110 in a side or profile view, as shown in FIG. 12. A frontal view of this third variant of the first exemplary embodiment is shown in FIG. 13. There it can be seen that a separate loop or sling 130′″-1, 130′″-2 loops around frame filling 110, in each instance, preferably at the right and left edge of the frame filling. The glass holder strips 150′″ or the plastic profiles 150″ cover the ropes or bands from the inside, making them invisible, as do the shanks that project on the casement frame, up to which shanks the sealant beads 150′ extend, from the outside.

Coming back to FIG. 12, the free ends of rope 130′″ which forms the loop or sling are shown there connected with one another. The one resulting free rope end is also shown anchored in casement frame 140. The anchoring in FIG. 12, in the form of a screw connection 137, is shown as an example.

The ropes or bands 130′″ shown in FIGS. 12 and 13, which run around the side of the glass edge, are preferably mounted so that they are not optically visible from the outside; this means that they are mounted hidden behind glass fittings or seals.

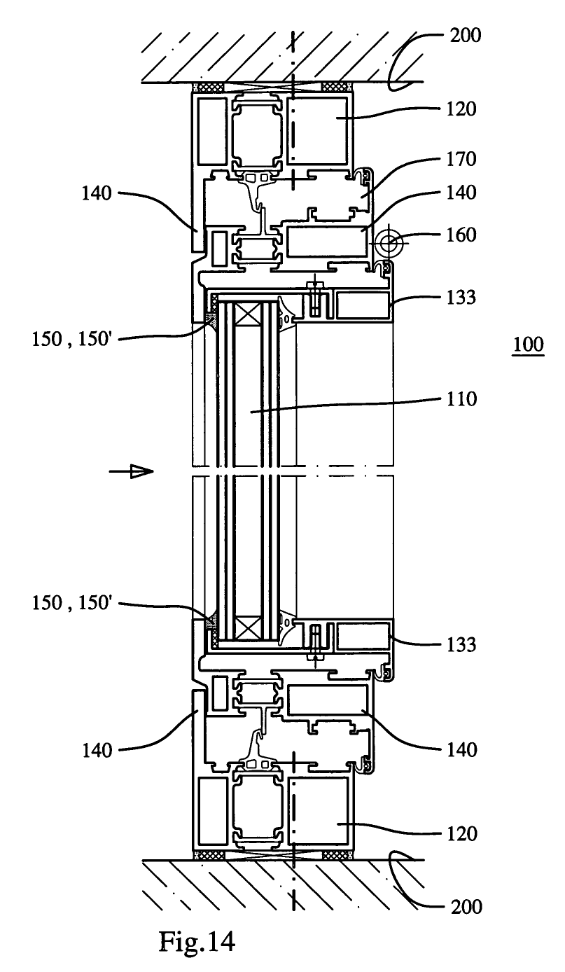

FIG. 14 again shows a profile view of a casement window, this time, however, with a second exemplary embodiment for retention device 130. In the case of the second exemplary embodiment shown here, the ropes or bands known as the first exemplary embodiment are replaced with an auxiliary frame 133 in connection with bands 160. Auxiliary frame 133 directly accommodates frame filling 110; here, frame filling 110, i.e. auxiliary frame 133, is connected with casement frame 140 by way of connection device 150, 150′—at a predefined adhesive force as determined by the predetermined or desired pressure threshold value.

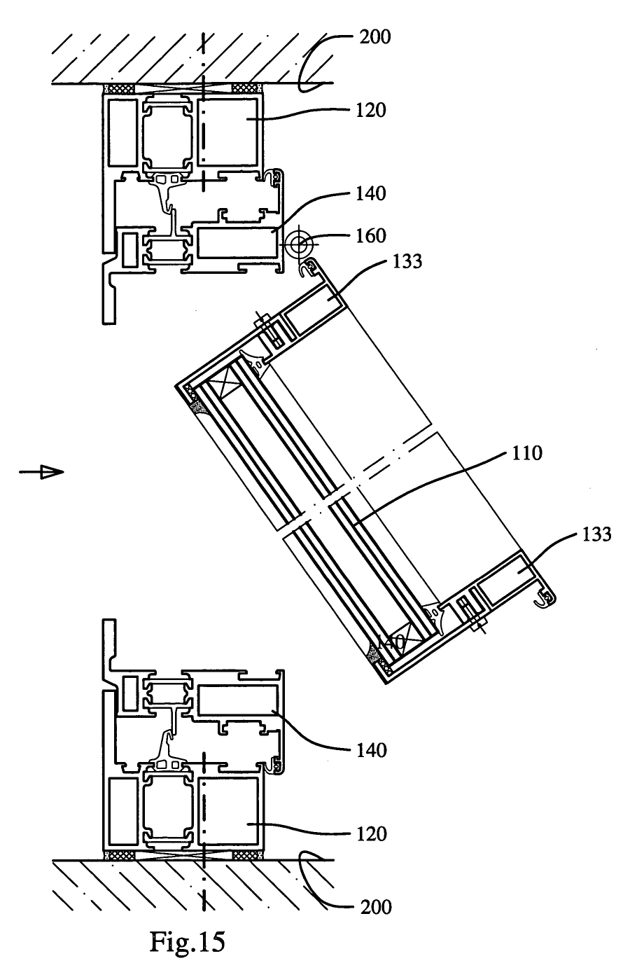

Here again, it is assumed that the connection between casement frame 140 and window frame 120, which is to be opened in the normal state, is designed to be stable enough to withstand a pressure wave, particularly an explosion-related pressure wave. It is also assumed that the casement frame would not open in this case. Instead, this connection device 150′ is designed as a planned breaking point, so that it would give way in the case of the effect of a pressure wave. The frame filling 110 would then burst out of its embedding in the casement frame 140, together with auxiliary frame 133 that accommodates it, and would rotate away about an axis of rotation defined by bands 160, or flip away in the direction of the double arrow, as shown in FIG. 15. Frame filling 110 then acts as a pressure-relieving flap in connection with the auxiliary frame, just like in connection with the rope or band 130′.

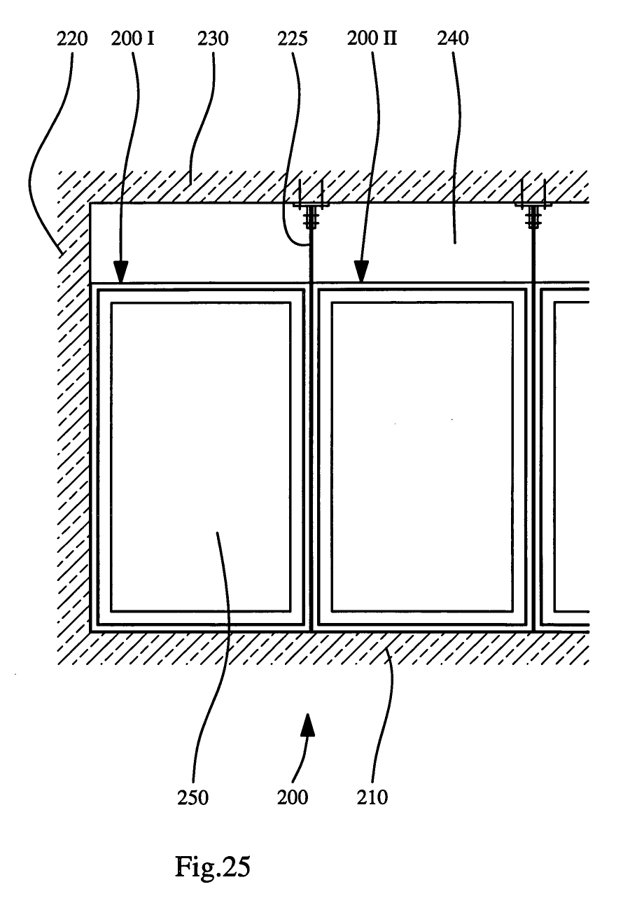

FIG. 25 shows a side view of a partition 200, which is attached on the one hand to a floor 210, on the other hand to a wall 220, and furthermore via struts 225 to a ceiling 230. The partition is composed of a plurality of identical partition elements 200 I, 200 II, etc. These elements abut one another and thereby form a continuous wall. Above the top edges of individual partition segments 200 I, 200 II, etc., there is an air space 240 that reaches to the ceiling 230.

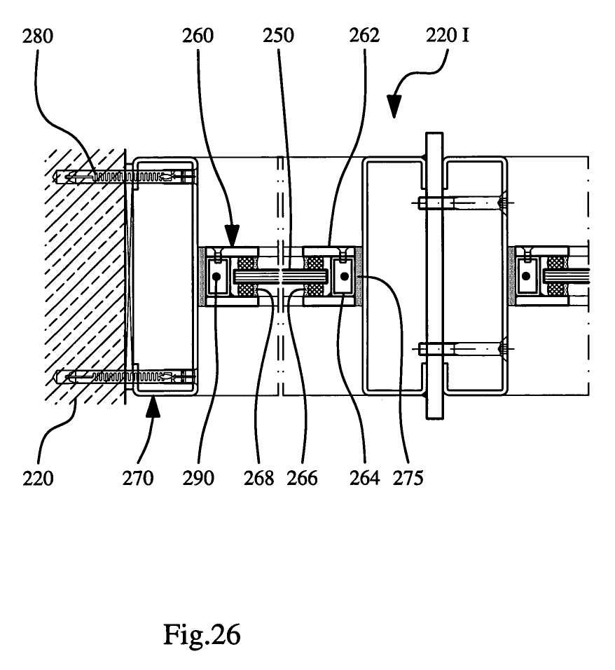

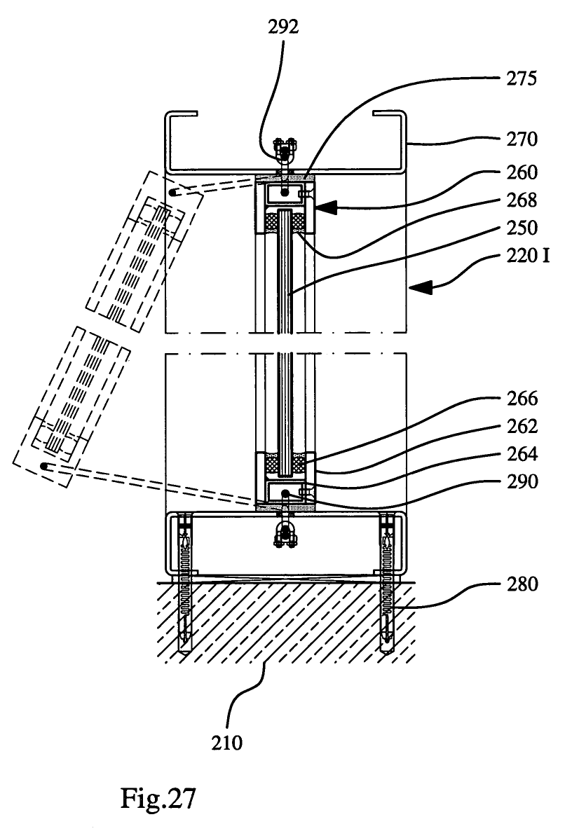

This partition wall segment 200 I, 200 II, etc. will be explained in greater detail in FIGS. 26 and 27. Partition wall segment 200I, 200II, etc. possesses a center filling 250 made of a sufficiently elastic glass material, particularly of polycarbonate, which can be structured in one layer or multiple layers. The polycarbonate pane is held on its circumference in an auxiliary frame 260, the shanks of which are formed of two flat steel sections 262 disposed on opposite sides of filling 250, in each instance, and a rectangular pipe 264 disposed between them. One flat steel section 262 is welded to rectangular pipe 264. The other flat steel section 262 is screwed onto rectangular pipe 264, in order to allow simple insertion of the pane after production of the auxiliary frame. In this connection, filling 250 is not supported directly on flat steel sections 262, but rather indirectly by way of a rubber-elastic profile cord 266. If necessary, a circumferential seal 268, for example of a silicone sealer, is also located above rubber profile cord 266.

Auxiliary frame 260 as described above is mounted within a frame 270 that is made up of C-shaped profiles. The mounting takes place with a certain play, whereby the circumferential joins are filled by means of an adhesive and sealing tape 275, which essentially extends over the entire width of the auxiliary frame. This frame is therefore able, in its normal state, to absorb the forces that usually act on it, particularly wind forces and forces in connection with touching filling 250 or auxiliary frame 260, without movement, and to pass them off into frame 270.

The outer frame is firmly anchored in floor 210 or wall 220 by means of screws and pegs 280.

From FIG. 27, it is evident that a retention device in the form of a wire cable 290 is passed out of the auxiliary frame 260 through a bore in the auxiliary frame 260, at the top as well as at the bottom of partition segment 220 I, and passed into the frame 270 through another bore in frame 270.

In frame 270, there are two cable presses 292, at the top and the bottom, in each instance, which are rigidly connected with frame 270. As is evident from FIG. 26, wire cable 290 is guided in rectangular pipe 264, on the circumference, by means of auxiliary frame 260. The cable, in total, possesses a certain free length. This length allows auxiliary frame 260 together with filling 250 to move essentially horizontally in both possible directions, if a pressure effect, particularly an explosion-related pressure effect, acts on filling 250 from one side. FIG. 27 shows how filling 250 with auxiliary frame 260 was displaced into an end position deflected out to the left, after an explosion pressure had acted on the partition from the right. Making filling 250 of sufficiently flexible material reliably prevents splintering. Filling 250 and auxiliary frame 260 are prevented from flying about in uncontrolled manner by means of the limited length of wire cable 290 and its firm fixation in frame 270 both at the top and at the bottom of the partition. Therefore, in the case of an explosion on only one side of the partition, which divides a large room into two rooms, for example, only a damped spread of the pressure wave into the areas shielded by partition 220 will occur. A shower of splinters that occurs in an area is prevented by the vertical orientation of the partition, which is essentially maintained even in the deflected case (the broken-line representation in FIG. 27).

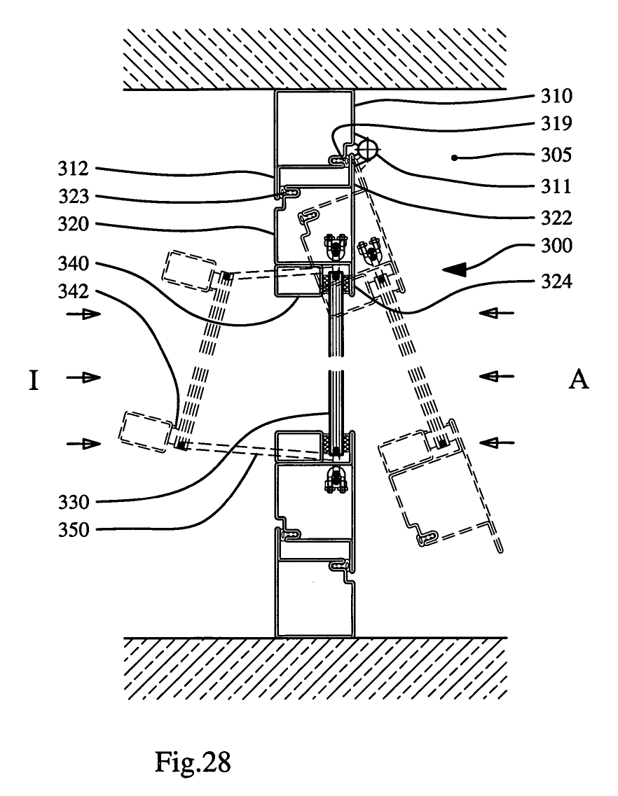

FIG. 28 shows a pressure relief flap 300, which is inserted into an opening 305 in a building. The pressure relief flap is made up of a window frame 310 and a casement frame 320 that is mounted in window frame 310 to pivot about a horizontal axis. Casement frame 320 possesses a filling 330 of several layers of polycarbonate that are glued to one another. Window frame 310 and casement frame 320 have folded regions 312, 322 that are disposed offset relative to one another. These folded regions interact with sealing profiles 313, 323 in the other frame, in each instance, and thereby bring about a tight seal between casement frame 320 and window frame 310 in the normal state.

The casement frame has another folded region 324 opposite folded region 322, which serves for unilateral support of the filling (by way of rubber profile cords or the like). Filling 330 is supported on the other side by circumferentially disposed glass holder strips (again by way of rubber profile cords or the like).

Contrary to usual practice in the construction of windows or doors, the glass holder strips are connected with casement frame 320 only so firmly that they come loose from the casement frame if a certain force threshold value that acts on them is exceeded. When an explosion pressure acts on pressure relief flap 300 from the right (outside A), filling 330 transfers the force to the glass holder strip 340. As a result, glass holder strips 340 come loose and filling 330 moves into the position shown with a broken line in FIG. 28, on the left, together with the glass holder strips. In this connection, glass holder strips 340 are connected with filling 330 with sufficient strength, for example by way of a circumferential seal 340, so that glass holder strips 340 are prevented from flying about. They constantly remain in connection with filling 330, which in turn is firmly connected with the casement frame by way of the retention device formed by a wire cable 350. Wire cable 350 is circumferentially placed in a groove on the four faces of filling 330, and there additionally fixed in place by means of an adhesive. Wire cable 350 is furthermore passed into the window frame 320 through bores in window frame 320, and fixed in place there by means of cable presses. As a result, an end position of filling 330, together with glass holder strips 340, is achieved, as soon as wire cable 350 is tightened. In this way, not only are individual parts prevented from flying about, but also the filling is prevented from swinging into the interior I of the building.

If a pressure wave were to occur in the interior I of the building, the filling itself cannot come loose from casement frame 320, because of the fold 324 in casement frame 320. Because of the explosion pressure that acts on the filling, however, casement frame 320 comes loose from its normal-state position within window frame 310. Only a flipping movement (shown with a broken line on the right of FIG. 28) is possible because of bands 311 disposed at the top. For the sake of simplicity, the connection device that fixes casement frame 320 in place in the window frame in the normal state is not shown in FIG. 28. It can take the form of a glue connection or the form of tear-away screws, for example, so that in both cases, a threshold force is defined, above which the connection is canceled out.

With this type of activation of the pressure relief flap, as well, casement frame 320 together with filling 330 is prevented from swinging outwards (A). Specifically, by means of a catching scissors mechanism, which is not shown but fixed in place on window frame 310, at the bottom, casement frame 320 and filling 330 are prevented from swinging outwards.

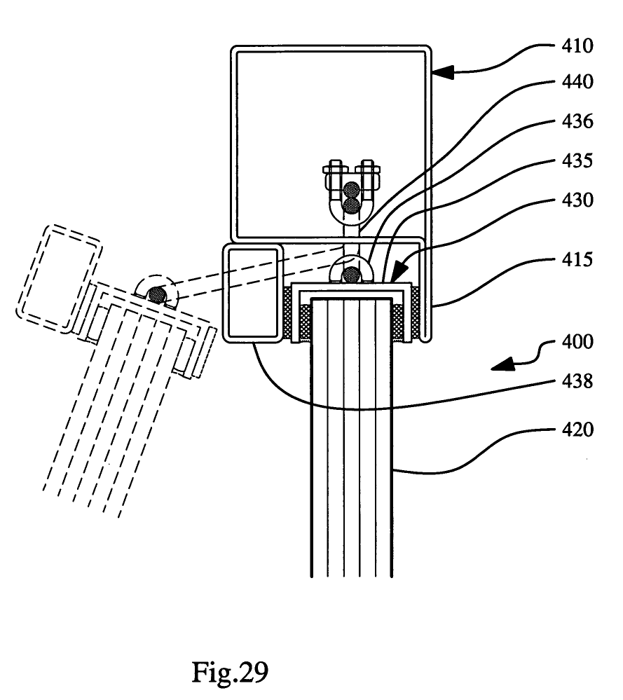

FIG. 29 shows a frame/glass combination in the form of a fixed field, made up of a window frame 410 and a filling 420 attached in it. If it is not possible to dispose a circumferential groove on the faces of filling 420, the filling can be formed with a circumferential auxiliary frame 430, made up of sections of U profiles 435. Eyes 436 are disposed on the ridge of U profiles 435, on the outside, through which eyes a wire cable 440 is guided parallel to the related face of filling 420. The circumferential sections of U profile 435 can be welded together at the corners, to form an auxiliary profile 430, or can be screwed together there, by way of separate corner connectors. Filling 420 is mounted in auxiliary frame 430 by way of rubber-elastic profiles as well as by way of additional sealing material.

Auxiliary frame 430 as described above is supported, on the one side, on a folded region 415 of window frame 410, on the one hand, specifically, again, by way of a rubber-elastic intermediate element. On the other side, U profile 435 is followed by a glass holder strip 438, which is rigidly connected with auxiliary frame 430 in a manner not shown in detail. In contrast, the connection between glass holder strip 438 and window frame 410 is structured so that it can be canceled out if a certain force threshold value is exceeded. If such a case occurs, filling 420, together with auxiliary frame 430, to which glass holder strips 438 are always connected, comes loose from window frame 410 as a unit. As a result, the end position shown with a broken line in FIG. 29 is assumed, in which wire cable 440 is stretched tightly.

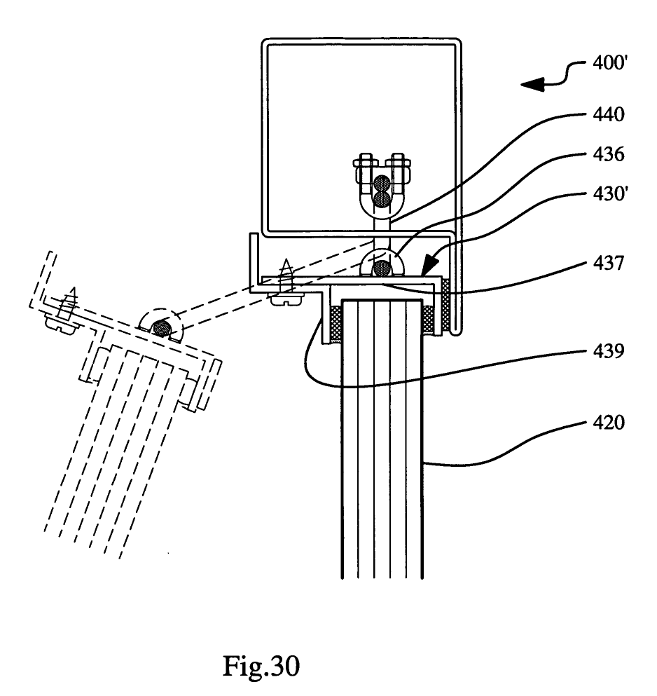

In the case of the frame/glass combination 400 shown in FIG. 30, auxiliary frame 430′ is formed from an L profile 437 and a Z profile 439 screwed onto L profile 437. Auxiliary frame 430′ surrounds filling 420 circumferentially and is connected with wire cable 440 by way of eyes. For the remainder, what was said with regard to FIG. 29 applies.

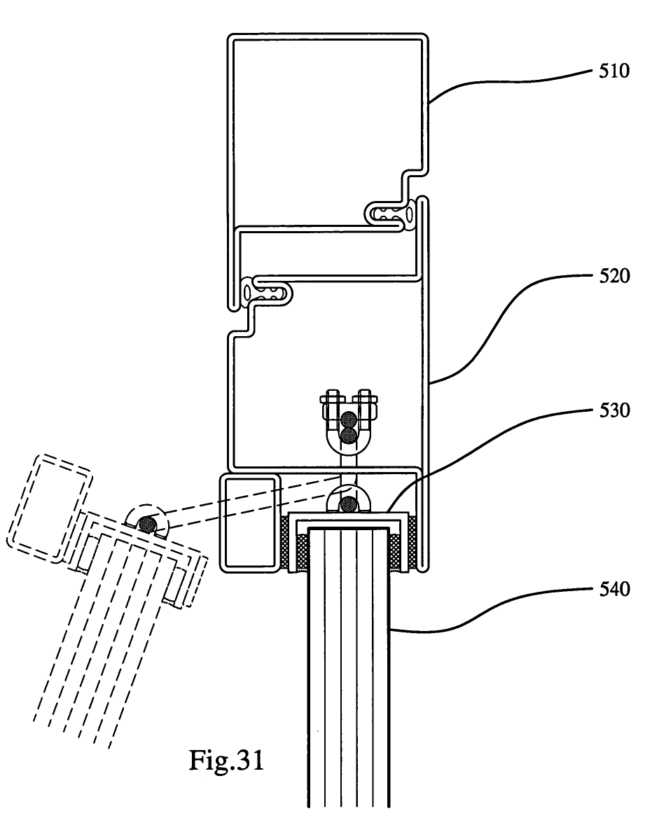

In the case of the frame/glass combination 500 shown in FIG. 31, a casement frame 520 is mounted to move in a window frame 510. Casement frame 520 in turn accommodates an auxiliary frame 530 that in turn surrounds a filling 540 circumferentially. With regard to how filling 540 together with auxiliary frame 540 is connected and mounted in casement frame 520, the same explanations as for the frame/glass combination 400 according to FIG. 29 apply. The sole difference is that the auxiliary frame is mounted not in the window frame but rather in the casement frame.

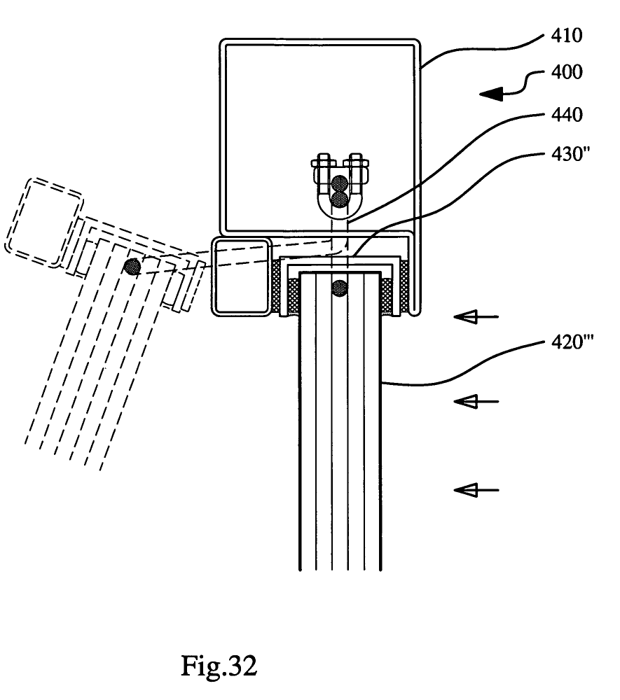

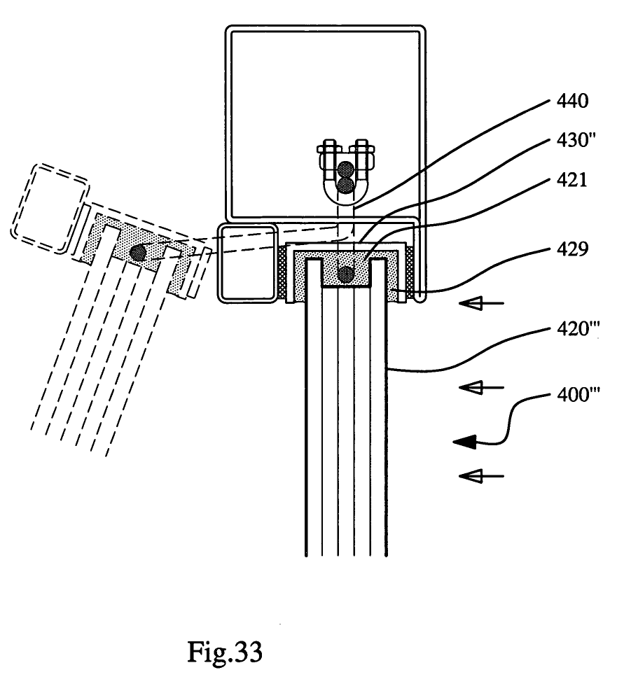

The fundamental mounting of filling 420′ in the case of the frame/glass combination 402′ according to FIG. 32 does not differ from that of the exemplary embodiment according to FIG. 29. It is true that the auxiliary frame 430″ also is made up of U-shaped profiles, but it does not possess any external eyes. Instead, wire cable 440 is accommodated in a corresponding channel in the interior of filling 420″, and guided through bores in auxiliary frame 430″ and in window frame 410, to cable presses in window frame 410. In the case of the exemplary embodiment according to FIG. 33, filling 420′″ there possesses a circumferential groove 421, rectangular in cross-section, into which wire cable 440 is laid. Cavities between auxiliary frame 430″, which is formed from U profiles, and filling 420′″, are filled with an adhesive sealing mass 429.

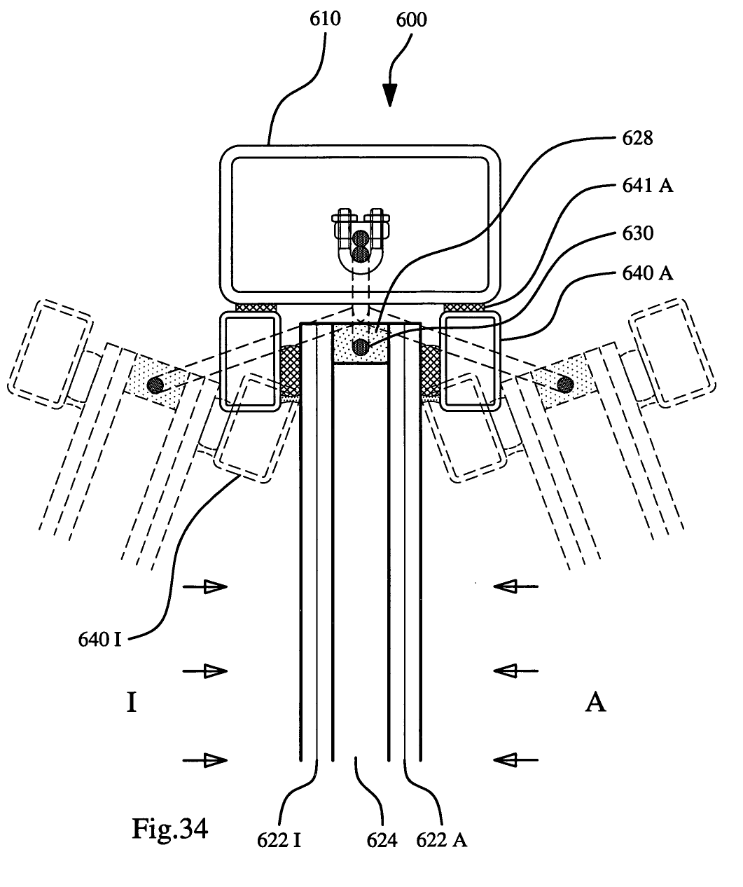

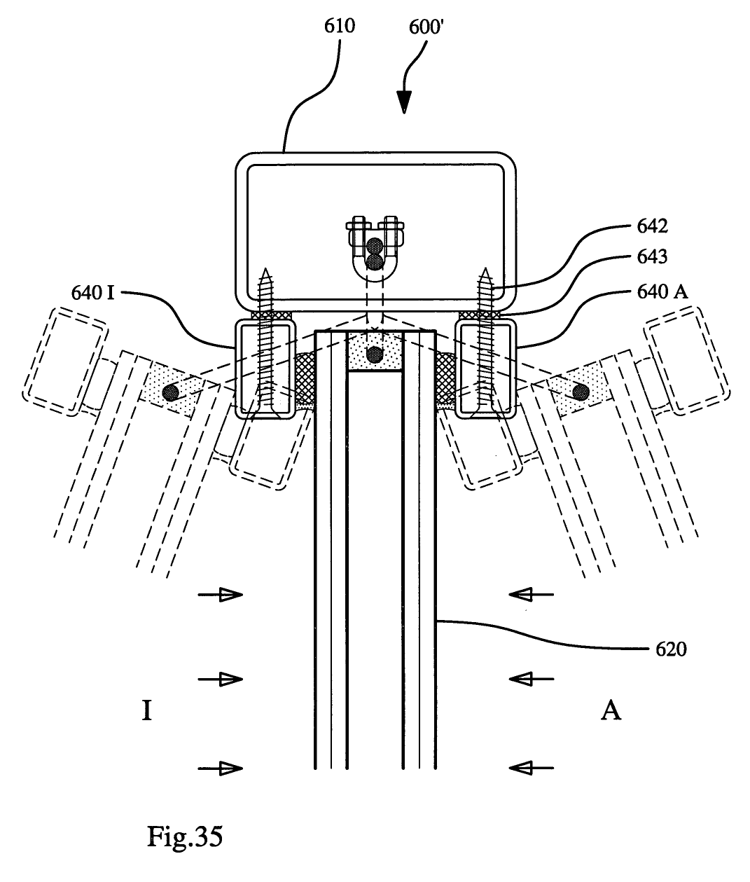

Finally, two alternative methods of securing the glass in fixed fields are shown in FIGS. 34 and 35, both of which allow displacement of the filling to both sides:

According to FIG. 34, a window frame 610 of a frame/glass combination 600 is formed from a rectangular pipe. A filling 620 is made up of two outer laminate glass panes 622 A and 622 I, in each instance, and a center pane 624, which is set back relative to the two outer laminate panes, so that a groove is formed on the circumference, into which a wire cable 630 is laid. The groove is subsequently filled with an adhesive/sealant 628. After looping around filling 620 at least once, the wire cable is passed into the interior of window frame 610 through a bore, and fixed in place there by means of cable presses.

Towards the outside, glass holder strips follow on both frontal sides of filling 620, in each instance, which are firmly connected with laminate glass panes 622 A and 622 I, in each instance. The two glass holder strips 640 A and 640 I, on the other hand, are connected with window frame 610 only by way of a weak glue bond 641 A, 641 I. If a certain force threshold value is exceeded, the two glue bonds 641 A, 641 I come loose at the same time. In this way filling 620 together with the two glass holder strips 640 A, 640 I that adhere to it can be displaced into an opening limitation position. This movement occurs in the case of an explosion pressure that impacts filling 620 both from the inside I and from the outside A.

The difference from the frame/glass combination 600′ shown in FIG. 35 is that in frame/glass combination 600′, glass holder strips 640 A and 640 I are attached to window frame 610 by means of shear-off screws 642. Also in this case, there is a seal 643 between window frame 610 and glass holder strips 640 A, 640 I, but this seal very intentionally does not perform an adhesive function. As a result, the force above which filling 620 together with glass holder strips 640 A and 640 I comes loose from the window frame 610 is determined solely by shear-off screws 642.

Although several embodiments of the present invention have been shown and described, it is to be understood that many changes and modifications may be made thereunto without departing from the spirit and scope of the invention as defined in the appended claims.

What is claimed is:

1. A frame/filling combination comprising
(a) a filling;
(b) a frame having an opening for direct or indirect accommodation of said filling during a normal state;
(c) a connection device for holding said filling in said frame in the normal state; and
(d) a retention device mounted between said filling and said frame for holding said filling in connection with said frame;
wherein said retention device holds said filling in connection with said frame even when said filling comes loose from the opening of said frame as a result of a force, said filling being removable from said frame by means of the force only if said connection device is destroyed.

2. The frame/filling combination according to claim 1, wherein said filling comprises a laminate glass pane for a window or a door and the force comprises an explosion-related force.

3. The frame/filling combination according to claim 1, wherein said connection device comprises a planned breaking point between the filling and the frame, said connection device giving way on one side of the filling at a force effect above a predetermined force threshold value, so that the filling only then comes loose from the opening of the frame.

4. The frame/filling combination according to claim 3, wherein said connection device comprises a sealant bead between the filling and the frame, the sealant having an adhesive strength selected on the basis of the predetermined force threshold value.

5. The frame/filling combination according to claim 4, wherein the sealant bead comprises silicone.

6. The frame combination according to claim 3, wherein said connection device is configured to seal the filling relative to the frame.

7. The frame/filling combination according to claim 6, wherein said connection device is configured to seal the filling relative to the frame against moisture.

8. The frame/filling combination according to claim 3, wherein said filling comprises a glass pane and said connection device has a glass holder strip for pressing the glass pane against the frame, the glass holder strip being attached to the frame by an attachment device so that the glass holder strip comes loose above a predetermined force threshold value.

9. The frame/filling combination according to claim 8, wherein the frame is a window frame firmly anchored in a rough opening of a wall, or a casement frame that is mounted to turn or tilt in a window frame.

10. The frame/filling combination according to claim 8, wherein the retention device comprises a rope or a band having a predetermined minimal tear strength.

11. The frame/filling combination according to claim 10, wherein the retention device comprises a wire cable or a woven fabric band.

12. The frame/filling combination according to claim 10, wherein the rope or band loops around the glass pane at least in sections, in front of or at a side of the glass pane.

13. The frame/filling combination according to claim 10, wherein the rope or band is formed as a closed loop.

14. The frame/filling combination according to claim 10, wherein the retention device has an attachment device for attaching the rope or the band.

15. The frame/filling combination according to claim 14, wherein the attachment device attaches the rope or the band to a frame element or to a structural component.

16. A frame/filling combination comprising
(a) a filling comprising a glass pane;
(b) a frame having an opening for direct or indirect accommodation of said filling during a normal state; and
(c) a retention device connected to the glass pane with a positive lock.

17. The frame/filling combination according to claim 16, wherein said retention device comprises a rope or band that engages in at least one groove in the glass pane.

18. The frame/filling combination according to claim 10, wherein the filling comprises a laminate glass pane formed from at least two individual glass panes spaced apart from one another by means of spacers, the spacers being offset away from an edge of the laminate glass pane towards a center portion of the laminate glass pane, at least in sections of the laminate glass plane, so that a groove is formed for guiding the rope or the band running circumferentially along the filling on at least two opposite sides, said groove being delimited by the spacers and the individual glass panes that project beyond the spacers.

19. The frame/filling combination according to claim 18, wherein a mass of sealant fills the groove with the rope or the band.

20. The frame/filling combination according to claim 2, wherein the retention device comprises an auxiliary frame in connection with bands, the auxiliary frame accommodating the laminate glass pane directly, and the opening of the frame accommodating the laminate glass pane indirectly.

21. The frame/filling combination according to claim 20, wherein the frame that accommodates the laminate glass pane indirectly is a window frame firmly anchored in a rough opening, or a casement frame that is mounted to turn or tilt in a window frame.

22. The frame/filling combination according to claim 1, wherein the retention device is guided so as not to be visible from outside of the frame/filling combination.

23. The frame/filling combination according to claim 2, wherein the retention device is guided in an interior portion of the laminate glass pane or of the frame so as not to be visible from outside of the frame/filling combination.

24. The frame/filling combination according to claim 1, wherein the retention device is covered by elements of a closing device comprising a cover band, a seal, or other frames.
